(19) United States
(12) Patent Application Publication
(10) Pub. No.: US 2008/0086561 A1
(43) Pub. Date: Apr. 10, 2008

(54) METHOD FOR OBTAINING LOG INFORMATION FROM NETWORK ELEMENT DEVICE BY NETWORK MANAGEMENT SERVER, A NETWORK ELEMENT DEVICE AND A NETWORK MANAGEMENT SERVER

(75) Inventors: Shujun DANG, Guangdong Province (CN); Li Yang, Guangdong Province (CN); Yuehua Chen, Guangdong Province (CN); Lan Zou, Guangdong Province (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Guangdong Province (CN)

(21) Appl. No.: 11/926,960

(22) Filed: Oct. 29, 2007

Related U.S. Application Data
(63) Continuation of application No. PCT/CN2006/000825, filed on Apr. 27, 2006.

(30) Foreign Application Priority Data
Apr. 27, 2005 (CN) 200510068653.4

(51) Int. Cl. G06F 15/16

(52) U.S. Cl. 709/224

(57) ABSTRACT

A method for the network management server to get the log information from the network element device comprises: firstly, the network element device allocates a section of the memory resource as the log buffer, and stores the log information generated by the network element device in the log buffer; then, the network element device detects dynamically the residual capacity of the log buffer, and when the residual capacity of the log buffer is less than the special threshold, it notifies the network management server to fetch the log information. The present invention can avoid the loss of the log information of network element device to ensure the categoricalness of the log information.

### FIELD OF THE INVENTION

The invention relates to network management technology, and in particular, to a method for obtaining log information from a network element device by a network management server.

### BACKGROUND OF THE INVENTION

In a network including a number of network element devices and a network management server, the network management server(s) manages the network element devices in a centralized manner. In some networks, especially mobile communication networks, the number of network element devices is increasing with the growth of the number of subscribers. Whenever a fault occurs on any network element device, the network management server is required to locate and eliminate the fault as soon as possible.

Log is an important record for the operation and maintenance of a network element device. Log may assist a network management and maintenance engineer to locate and eliminate a fault as soon as possible. Therefore, in a network that manages a number of network element devices, such as a World Interoperability for Microwave Access (Wimax) system, it is necessary for a network management server to obtain log information of the network element devices conveniently in a centralized manner, to prevent the log information of the network element devices from being lost, and to provide a centralized browsing interface. So the management and maintenance engineer may browse the log information of some network element devices conveniently.

In a conventional system, a network management server generally employs the Simple Network Management Protocol (SNMP) to obtain the log information of network element devices. The particular implementation may be as follows: Among the network element devices managed by a network management server, each network element device is provided with an SNMP management information base (MIB) node. The MIB node further includes an Eventlog node for storing Eventlog data of the network element device. The network management server may obtain log information from the network element devices in a predefined manner.

The Eventlog node will be described below with a base station (BS) network element device in a WiMAX system as an example. FIG. 1 is a schematic diagram illustrating the data structure of an Eventlog node in a conventional BS network element device. As shown in FIG. 1, the Eventlog node contains 3 data tables, including a data table for storing user-defined parameters, i.e. wmanIfBsEventLogConfigTable, a data table for storing log types supported by the BS, i.e. wmanIfBsEventTable, and a data table for storing log information of the BS, i.e. wmanIfBsEventLogTable. The wmanIfBsEventLogTable is a buffer, the capacity of which is generally a constant. The BS network element device usually records the log information in the buffer in a circular writing manner. The network management server communicates with the Eventlog node of the network element device via an SNMP interface, and obtains log information from the wmanIfBsEventLogTable of the Eventlog node through operations such as Get/GetNext/GetBulk in the SNMP, so as to manage the network element device according to the log information.

However, the log information is recorded in the buffer in a circular writing manner by the network element device to record. In this way, old log information may be overwritten by new log information when the buffer is full. Further, with the operations such as Get/GeNext in the SMNP, log information can only be obtained from the buffer item by item, or only a small amount of log information can be transferred at one time. In other words, the log information can not be obtained in bulk, so that the rate of obtaining the data is low. As a result, if there is no enough space in the buffer and the network management server does not obtain the log information in time, a part of the log information may be lost, which exerts a severe impact on the integrity of the log information. The non-integrity of the log information makes it difficulty for the network management server to manage the network element device effectively and properly.

In addition, in the above-described prior art, a reason why the network management server can not obtain the log information in time lies in that the network management server can not learn the capacity of the buffer for recording the log information in the network element device in time.

### SUMMARY OF THE INVENTION

The invention provides a method for obtaining log information from a network element device by a network management server, so as to effectively prevent the loss of log information buffered in the network element device, and ensure the integrity of the log information got by the network management server.

The technical schemes according to the invention are as follows.

a method for obtaining log information from a network element device by a network management server provided in the invention may includes:
A. storing, by a network element device, log information generated by the network element device into log storage space;
B. when utilization status of capacity of the log storage space meets a predefined condition, obtaining, by the network management server, the log information stored in the log storage space.

Optionally, the step B may include:
detecting, by the network element device, the utilization status of capacity of the log storage space; sending a notification message to the network management server when the utilization status of capacity of the log storage space meets the predefined condition; when receiving the notification message, reading, by the network management server, the log information stored in the log storage space; or
detecting, by the network element device, the utilization status of capacity of the log storage space; directly sending the log information stored in the log storage space to the network management server when the utilization status of capacity of the log storage space meets the predefined condition.

Optionally, in the step B, detecting by the network element device the utilization status of capacity of the log storage space may include:
detecting, by the network element device, whether the remaining capacity of the log storage space is less than a predefined threshold or whether occupied capacity exceeds another predefined threshold; if the remaining capacity of the log storage space is less than the predefined threshold or the occupied capacity exceeds the another predefined threshold, determining that the utilization status of capacity of the log storage space meets the predefined condition.

Optionally, there may be at least one threshold. When there are two or more thresholds, each threshold corresponds to one warning level upon which the network element device reports a notification message to the network management server.

Optionally, the threshold may be a percentage value configured with respect to the capacity of the log storage space, or a number of bytes.

Optionally, the notification message sent by the network element device to the network management server is a TRAP message.

Optionally, the method may further include:
when reading by the network management server the log information stored in the log storage space of the network element device successfully, sending by the network management server, a notification to the network element device requesting the network element device to delete the log information that has been read.

Optionally, the method may further include:
when receiving the notification sent by the network management server requesting the network element device to delete the log information that has been read from the log storage space, storing, by the network element device, the log information into a local log file, and deleting the log information from the log storage space.

Optionally, the method may further include:
when directly sending the log information stored in the log storage space to the network management server, deleting, by the network element device, the log information from the log storage space if receiving a reception acknowledgement message returned by the network management server.

Optionally, the method may further include:
storing, by the network element device, the log information into a local file of the network element device.

Optionally, the step A may include:
allocating a segment of storage resource as the log storage space, the storage resource being a permanent storage medium.

Optionally, the method may be applied to a network management system of a wireless metropolitan area network.

A network element device in a wireless metropolitan area network provided in the invention may include a log function entity. The log function entity includes:
a log storage module, utilized as storage space of log information, adapted for storing log information generated by the network element device;
a monitoring module, adapted for monitoring and reporting utilization status of the storage space in the log storage module; and
a threshold warning processing module, adapted for notifying a network management server to read the log information from the log storage module based on the monitored utilization status of the storage space in the log storage module.

Optionally, the threshold warning processing module may include:
a determination module, adapted for determining whether currently utilized portion of the storage space exceeds a predefined threshold, or whether unused portion of the storage space is less than another predefined threshold, based on the utilization status of the storage space in the log storage module, and sending a notification if the currently utilized portion of the storage space exceeds the predefined threshold or the unused portion of the storage space is less than the another predefined threshold; and
a notification message sending module, adapted for generating and sending a notification message to the network management server when receiving the notification sent from the determination module.

Optionally, the network element device may further include:
a log information management module, adapted for storing the log information locally in the network element device, and/or receiving a deletion command sent from the network management server, and deleting log information in the log storage module in response to the deletion command.

A network management server in a wireless metropolitan area network provided in the invention may include a log information management function entity. The log information management function entity includes:
a notification message receiving module, adapted for receiving a notification message sent from a network element device, and sending the notification message;
a log information reading module, adapted for reading log information from the network management device when receiving the notification message from the notification message receiving module.

Optionally, the network management server may further include:
a remote log information management module, adapted for returning a deletion command message to the network element device when reading the log information successfully from the network element device, to notify the network element device to delete the log information from a log storage module.

Another method for obtaining log information from a network element device by a network management server provided in the invention includes:
A. storing, by a network element device, log information generated by the network element device into log storage space;
B. notifying, by the network element device, utilization status of capacity of the log storage space to the network management server.

Optionally, the step B may include:
detecting, by the network element device, the utilization status of capacity of the log storage space, and sending a notification message to the network management server when the utilization status of capacity of the log storage space meets a predefined condition.

Optionally, in the step B, detecting by the network element device the utilization status of capacity of the log storage space may include:
detecting, by the network element device, whether remaining capacity of the log storage space is less than a predefined threshold or whether occupied capacity exceeds another predefined threshold; if the remaining capacity of the log storage space is less than the predefined threshold or the occupied capacity exceeds the another predefined threshold, determining that the utilization status of capacity of the log storage space meets the predefined condition.

Optionally, there may be at least one threshold. When there are two or more thresholds, each threshold corresponds to one warning level that the network element device reports a notification message to the network management server.

Optionally, the threshold may be a percentage value configured with respect to the capacity of the log storage space, or a number of bytes.

Optionally, notifying by the network element device utilization status of capacity of the log storage space to the network management server may include: sending a TRAP message.

The beneficial effects of the invention lie in that: in the invention, a network element device utilizes log storage space to store log information, and a network management server obtains the log information stored in the log storage space based on the utilization status of the capacity of the log storage space. In this way, all log information may be obtained by the network management server, so that the log information may be prevented from being lost, and the integrity of the log information is ensured.

The network element device detects the remaining capacity of the log storage space. When the remaining capacity is less than a certain value, the network element device sends a notification message to the network management server. When receiving the notification message, the network management server initiates an SNMP process to read log information from the log storage space of the network element device managed by the network management server, so that all log information may be obtained by the network management server, thereby preventing the log information from being lost and ensuring the integrity of the log information. In this way, the network management server can manage the network element device effectively and properly based on the log information, locate and eliminate a fault rapidly when the fault occurs, thereby improving the satisfactory degree of the users.

Furthermore, in the invention, the network element device may store the log information into a local file. For one thing, the local file storing the log information may be analyzed by a local manager. For another, the local file storing the log information may be transferred to network side and analyzed by a manager at the network side so that the manager may locate a fault. Using a file to store log information of local network element may further guarantee the integrity of the log information of the local network element.

Furthermore, in the invention, the network element device sends a notification to the network management server when detecting the utilization status of capacity of the log storage space. In this way, the network management server may learn the utilization status of capacity of the log storage space in time, and thus process accordingly.

### BRIEF DESCRIPTION OF THE DRAWINGS

FIG. 1 is a schematic diagram illustrating the data structure of an Eventlog node in an conventional BS network element device;

FIG. 2 is a flow chart of the operation in network element device side according to the invention;

FIG. 3 is a flow chart showing a network management server obtaining log information from a network element device;

FIG. 4 is a flow chart showing a network element device processes locally-stored log information according to the invention;

FIG. 5 is a schematic diagram illustrating the structure of a network element device in a WMAN network;

FIG. 6 is a schematic diagram illustrating the structure of a network management server in a WMAN network.

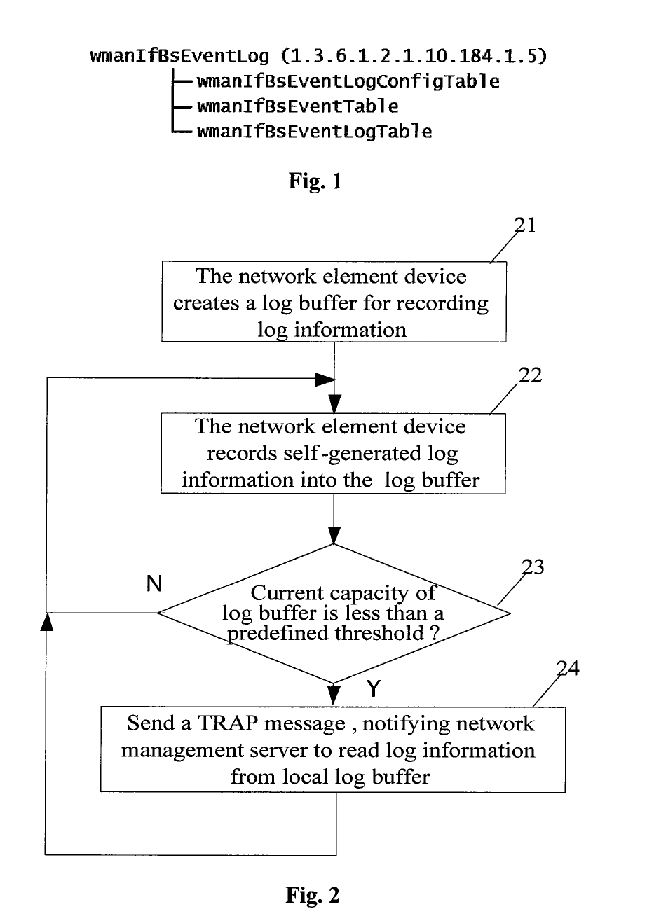

### DETAILED DESCRIPTION OF THE EMBODIMENTS

The invention will be further described with reference to the accompanying drawings and some embodiments.

In a method of the invention, a log buffer is utilized to store log information in a network element device, and the remaining capacity of the log buffer is detected dynamically. When the remaining capacity of the log buffer for storing the log information is less than a predefined value, for example, when log information stored in the log buffer occupies 20% of the overall capacity of the log buffer (of course, a person of ordinary skilled in the art shall appreciate that the defined value depends on particular situations and practical requirements, and is not limited to 20% of the overall capacity), a message is sent to notify a network management server. Upon receiving the message, the network management server may initiate a particular SNMP process to read log information from the log buffer of the network element device managed by the network management server.

In addition, in the invention, the network element device managed by the network management server may store the log information into a local file which may be utilized locally or by a remote device when required.

The invention will be described in detail below in a WiMAX scenario, whereas the invention may be applied to many other scenarios. In the Wimax scenario, the network element device includes, but not limited to, Base station (BS) network element device and Subscriber station (SS) network element device.

The method for obtaining log information from a network element device according to invention includes a process of network element device and a process of a network management server. The method will be described in detail with reference to the accompany drawings.

FIG. 2 shows the process of a network element device, including the follows.

Step 21, the network element device creates a log buffer for storing log information.

When creating the log buffer for storing log information, the space occupied by the log buffer for storing log information may be predefined.

The log buffer is usually a permanent storage medium, such as a disk of a computer, so as to ensure the reliability of log information storage.

Step 22, the network element device records self-generated log information into the log buffer for storing log information.

Step 23, it is determined whether the remaining capacity of the log buffer for storing log information is less than a certain threshold, for example, 20% of the overall capacity of the log buffer. If the remaining capacity of the log buffer for storing log information is less than the certain threshold, the process proceeds to step 24, otherwise, the process returns to step 22.

In fact, in step 23, it is to determine whether the utilization status of the capacity of the log buffer meets a predefined condition, for example, whether the remaining capacity available is less than a predefined threshold, or whether the occupied capacity exceeds a predefined threshold, and so on.

In the step 23, there may be one threshold, or there may be two or more thresholds. When there is more than one threshold, each threshold corresponds to a warning level that a network element device reports a notification message to the network management server. In this case, the network management server is required to process in different manners for the different warning levels.

When configuring the threshold(s), it should be taken into account that the network management server is required to read the log information stored in the log buffer before the remaining capacity of the log buffer is used up so as to prevent the log information from being lost.

The thresholds may be configured as percentage values of the capacity of the log buffer, or may be configured as numbers of bytes for individual log buffers, and so on.

Step 24, the network element device sends a TRAP message notifying the network management server to read the log information, and the process returns to step 22.

In the invention, the network management server may obtain log information from the network element device by using a periodic query method, or when receiving the TRAP message from the network element device. Here a process of obtaining log information from the network element device when receiving a TRAP message will be described. Other methods for obtaining log information from the network element device by the network management server will not be described herein.

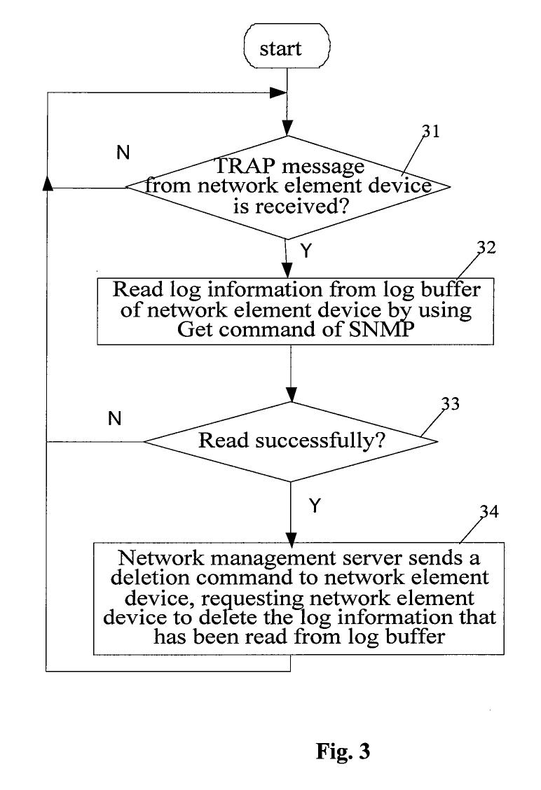

FIG. 3 shows a process of obtaining log information from a network element device by a network management server when the network management server receives a TRAP message according to the invention. The process is as follows.

Step 31, the network management server determines whether a TRAP message sent from the network element device is received. The TRAP message is used to request the network management server to read log information from the network element device. If the TRAP message is received, the network management server executes step 32, otherwise, the network management server continues executing step 31, waiting for the TRAP message sent from the network element device.

Step 32, the network management server initiates an SNMP command, such as Get or Getbulk, to the network element device, to read log information of the network element device.

Step 33, it is determined whether the log information of the network element device is read normally. If the log information of the network element device is read normally, the process proceeds to step 34, otherwise, returns to step 31.

Step 34, the network management server sends a deletion command to the network element device, requesting the network element device to delete the log information that has been read. Then, the process returns to step 31.

In the method according to the invention, the network element device may store log information of the network element device locally. Particularly, the network element device may store the log information into a local log file while storing the log information into the log buffer, and may store the log information to be deleted to the local log file while deleting the log information from the log buffer.

The network element device stores log information locally so that on one hand a local manager may analyze the local log file, and on the other hand, the local log file may be transferred to network side such that a manager at the network side may analyze the local log file and locate faults.

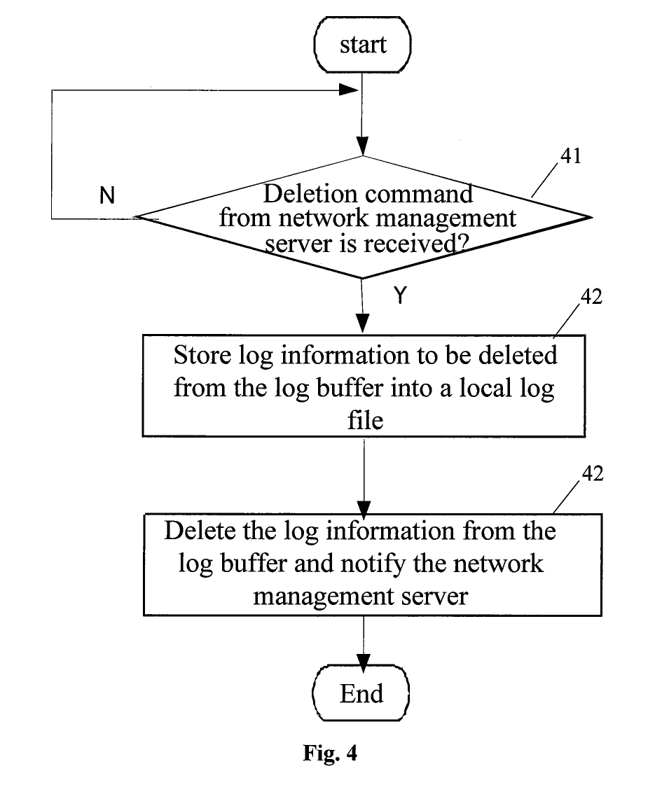

In practical applications, when receiving a deletion command from the network management server, the network element device may store the log information to be deleted into the local log file. FIG. 4 shows a particular process, which is as follows.

Step 41, the network element device determines whether a deletion command sent from the network management server is received. The deletion command is used to request the network element device to delete some of log information stored in a log buffer. If the deletion command is received, the network element device executes step 42, otherwise, the network element device continues executing step 41, waiting for the deletion command sent from the network management server.

Step 42, the network element device stores log information into a local log file. The log information includes, but is not limited to, log information in the log buffer that the network management server requests the network element device to delete.

Step 43, the network element device deletes the log information. The log information deleted is included in log information in the log buffer that the network management server requests the network element device to delete. In other words, the log information deleted is the log information that the deletion command from network management server requests to delete.

When deleting the log information, the network element device notifies the network management server that the log information has been deleted.

In addition, in another embodiment of the invention, when the utilization of the capacity of log storage space meets a predefined condition, the network element device may send the log information stored in the log storage space directly to the network management server.

When sending the log information stored in the log storage space directly to the network management server, if receiving a reception acknowledgement message returned by the network management server, the network element device deletes the log information stored in the log storage space.

In the embodiments of the invention, the local log file for storing log information of the network element device may be of the format of an Extendible marking language (XML) file.

Each item of log information that is stored may include: operation starting time, operation ending time, operation execution result, IP address of operation initiator, and detailed description of operation.

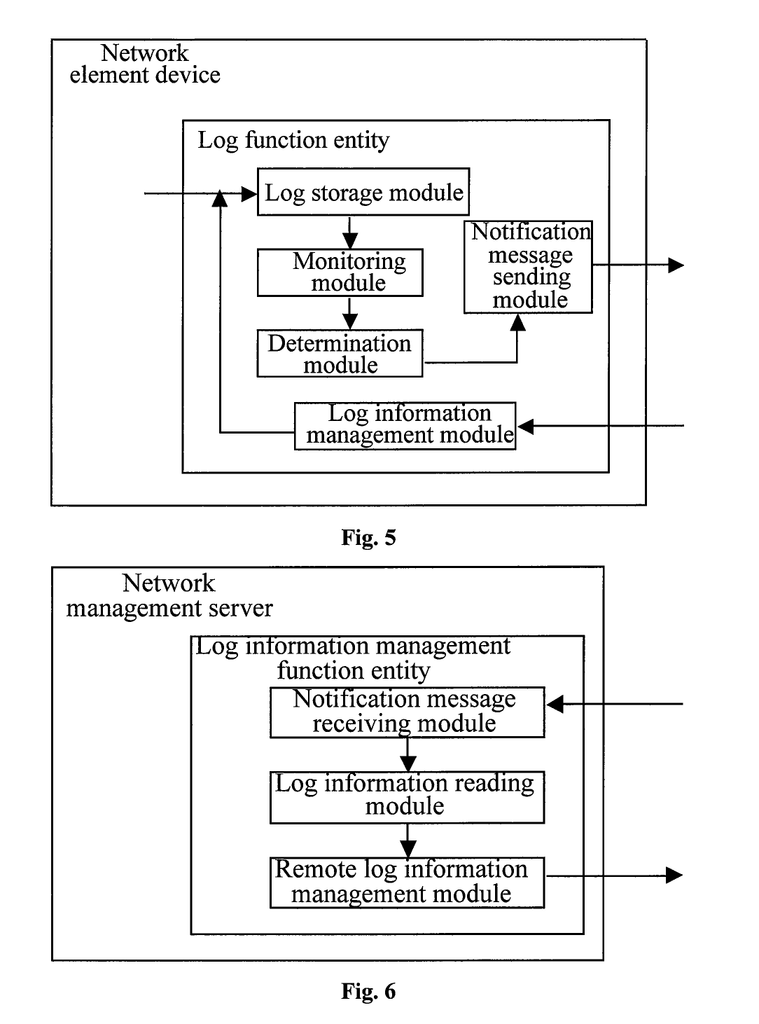

FIG. 5 shows a network element device in a wireless metropolitan area network (WMAN) according to the invention. The network element device includes a log function entity. The log function entity includes:

a log storage module, utilized as storage space of log information, adapted for storing log information generated by the network element device. Particularly, the log storage module may be a disk of a computer;

a monitoring module, adapted for monitoring and reporting utilization status of the storage space in the log storage module; and

a threshold warning processing module, adapted for notifying a network management server to read the log information from the log storage module based on the monitored utilization status of the storage space in the log storage module.

Particularly, the threshold warning processing module may include a determination module adapted for determining whether currently utilized portion of the storage space exceeds a predefined threshold, or whether unused portion of the storage space is less than another predefined threshold, based on the utilization status of the storage space in the log storage module, and sending a notification if the currently utilized portion of the storage space exceeds the predefined threshold or the unused portion of the storage space is less than the another predefined threshold (The determination process has been described above, and will not be repeated); and

a notification message sending module, adapted for generating and sending a notification message to the network management server when receiving the notification sent from the determination module.

In addition, the log function entity in the network element device may also include a log information management module, adapted for storing log information locally in the network element device, and/or receiving a deletion command sent from the network management server, and deleting corresponding log information in the log storage module in response to the deletion command.

FIG. 6 shows a network management server in a wireless metropolitan area network (WMAN) according to the invention. The network management server includes a log information management function entity.

Particularly, the log information management function entity includes:

a notification message receiving module, adapted for receiving a notification message sent from a log function entity of a network element device, and sending the notification message;

a log information reading module, adapted for initiating a log information reading function, e.g., a corresponding SNMP process, when receiving the notification message from the notification message receiving module, to read log information from the log function entity of the network management device.

In addition, the network management server may further include a remote log information management module, adapted for returning a deletion command message to the log function entity of the network element device when the log information is read successfully from the log function entity of the network element device, notifying the log function entity of the network element device to delete the log information from a log storage module of the log function entity.

While some preferred embodiments of the invention have been described above, the invention shall not be limited to this. Any variation or substitution recognized readily by a person of ordinary skill in the art based on the disclosure of the invention shall be covered within the protection scope of the invention.

1. A method for obtaining log information from a network element device by a network management server, comprising:
storing, by a network element device, log information generated by the network element device into log storage space;
when utilization status of capacity of the log storage space meets a predefined condition, obtaining, by the network management server, the log information stored in the log storage space.

2. The method according to claim 1, wherein, obtaining log information stored by the network element device in log storage space comprises:
reading, by the network management server, the log information stored in the log storage space upon receiving a notification message from the network element device; or
receiving by the network management server the log information stored in the log storage space Sent by the network element device.

3. The method according to claim 1, further comprising:
detecting, by the network element device, whether remaining capacity of the log storage space is less than a first predefined threshold or whether occupied capacity exceeds a second predefined threshold;
determining that the utilization status of capacity of the log storage space meets the predefined condition if the remaining capacity of the log storage space is less than the predefined threshold or the occupied capacity exceeds the another predefined threshold.

4. The method according to claim 3, wherein, there is at least one first threshold or at least one second threshold; when there are two or more first thresholds or there are two or more second thresholds, each threshold corresponds to one warning level that the network element device reports a notification message to the network management server.

5. The method according to claim 3, wherein, the threshold is a percentage value configured with respect to the capacity of the log storage space, or a number of bytes.

6. The method according to claim 2, wherein, the notification message sent by the network element device to the network management server is a TRAP message.

7. The method according to claim 2, further comprising:
when reading by the network management server the log information stored in the log storage space of the network element device successfully, sending by the network management server, a notification to the network element device requesting the network element device to delete the log information that has been read.

8. The method according to claim 7, further comprising:
when receiving the notification sent by the network management server requesting the network element device to delete the log information that has been read from the log storage space, storing, by the network element device, the log information into a local log file, and deleting the log information from the log storage space.

9. The method according to claim 2, further comprising:
when directly sending the log information stored in the log storage space to the network management server, deleting, by the network element device, the log information from the log storage space if receiving a reception acknowledgement message returned by the network management server.

10. The method according to claim 1, further comprising:
storing, by the network element device, the log information into a local file of the network element device.

11. The method according to claim 1, wherein, storing by the network element device log information generated by the network element device into log storage space comprises:
allocating a segment of storage resource as the log storage space, the storage resource being a permanent storage medium.

12. The method according to claim 1, wherein, the method is applied to a network management system in a wireless metropolitan area network.

13. A network element device in a wireless metropolitan area network, comprising a log function entity, wherein, the log function entity comprises:
a log storage module, adapted for storing log information of the network element device; and
a monitoring module, adapted for monitoring and reporting utilization status of the storage space in the log storage module;

14. The network element device according to claim 13, wherein, the threshold warning processing module comprises:
a threshold warning processing module, adapted for notifying a network management server to read the log information from the log storage module based on the monitored utilization status of the storage space in the log storage module;
a determination module, adapted for determining whether currently utilized portion of the storage space meets a predefined condition, and
a notification message sending module, adapted for generating and sending a notification message to the network management server when the currently utilized portion of the storage space meets the predefined condition.

15. The network element device according to claim 13, further comprising:
a log information management module, adapted for storing the log information locally in the network element device, and/or receiving a deletion command sent from the network management server, and deleting log information in the log storage module in response to the deletion command.

16. A network management server in a wireless metropolitan area network, comprising a log information management function entity, wherein, the log information management function entity comprises:
a notification message receiving module, adapted for receiving a notification message sent from a network element device, and sending the notification message;
a log information obtaining module, adapted for obtaining log information from the network management device when receiving the notification message from the notification message receiving module.

17. The network management server according to claim 16, further comprising:
a remote log information management module, adapted for returning a deletion command message to the network element device when reading the log information successfully from the network element device, to notify the network element device to delete the log information from a log storage module.

18. A method for obtaining log information from a network element device by a network management server, comprising:
storing, by a network element device, log information generated by the network element device into log storage space;
notifying, by the network element device, utilization status of capacity of the log storage space to the network management server.

19. The method according to claim 18, wherein, notifying by the network element device utilization status of capacity of the log storage space to the network management server comprises:
detecting, by the network element device, the utilization status of capacity of the log storage space; sending a notification message to the network management server when the utilization status of capacity of the log storage space meets a predefined condition.

20. The method according to claim 19, wherein, detecting by the network element device the utilization status of capacity of the log storage space comprises:
detecting, by the network element device, whether remaining capacity of the log storage space is less than a predefined threshold or whether occupied capacity exceeds another predefined threshold; if the remaining capacity of the log storage space is less than the predefined threshold or the occupied capacity exceeds the another predefined threshold, determining that the utilization status of capacity of the log storage space meets the predefined condition.

21. The method according to claim 20, wherein, there is at least one threshold; when there are two or more thresholds, each threshold corresponds to one warning level that the network element device reports a notification message to the network management server.

22. The method according to claim 20, wherein, the threshold is a percentage value configured with respect to the capacity of the log storage space, or a number of bytes.

23. The method according to claim 18, wherein, notifying by the network element device utilization status of capacity of the log storage space to the network management server comprises: sending a TRAP message.

24. A method for obtaining log information from a network element device by a network management server, comprising:
obtaining, by the network management server, log information stored by the network element device in log storage space if utilization status of capacity of the log storage space meets a predefined condition.

25. The method according to claim 24, further comprising:
reading, by the network management server, the log information stored in the log storage space upon receiving a notification message from the network element device; or receiving, by the network management server, the log information stored in the log storage space sent by the network element device.
